(19) United States
(12) Patent Application Publication
(10) Pub. No.: US 2008/0207813 A1
(43) Pub. Date: Aug. 28, 2008

(54) Power and/or telecommunications cable having improved fire-retardant properties

(76) Inventors: Jerome Fournier, Lyon (FR); Arnaud Piechaczyk, Lyon (FR); Olivier Pinto, Lyon (FR); Jean-Pierre Pascault, Villeurbanne (FR); Francoise Fenouillot, L'Isle D' Abeau (FR); Laurent Tribut, Lyon (FR)

Correspondence Address: SOFER & HAROUN LLP., 317 MADISON AVENUE, SUITE 910, NEW YORK, NY, 10017, US

(21) Appl. No.: 12/012,611

(22) Filed: Feb. 4, 2008

(30) Foreign Application Priority Data
Feb. 9, 2007 (FR) 07 53160

(51) Int. Cl. C08K 3/22; C08G 8/10; C08G 18/00; C08G 63/00; C08L 61/10

(52) U.S. Cl. 524/436; 525/480; 525/452; 525/123; 525/132; 524/539; 524/541; 524/437

(57) ABSTRACT

The present invention provides a power and/or telecommunications cable including at least one layer of a material obtained from a composition comprising: a thermoplastic polymer matrix; and a phenolic resin; wherein said phenolic resin is selected from novolac phenol-formaldehyde resins and novolac cyanate ester resins, and wherein said material includes nodules of hardened phenolic resin dispersed throughout the material.

### RELATED APPLICATION

This application claims the benefit of priority from French Patent Application No. 07 53160, filed on Feb. 9, 2007, the entirety of which is incorporated herein by reference.

### FIELD OF THE INVENTION

The present invention relates to a power and/or telecommunications cable having improved fire-retardant properties.

### BACKGROUND OF THE INVENTION

Document FR-2 684 793 describes a material comprising a polar matrix of the ethylene co-polymer type, a non-polar matrix selected from polypropylene and polyethylenes, and a phenolic resin of the resole type including terminal methyl groups and metallic hydroxides.

That material, having mechanical properties and thermal aging properties that do not require cross-linking of the thermoplastic matrix, is used in particular for insulating electric cables.

Nevertheless, that type of insulating material responds to fire in ways that are not optimized presents and mechanical properties that are not very satisfactory.

Thus, the technical problem to be solved by the subject matter of the present invention is to propose a power and/or telecommunications cable including at least one layer of a material obtained from a composition comprising a thermoplastic polymer resin and a phenolic resin, said cable making it possible to avoid the problems of the prior art, in particular by providing significantly improved resistance to fire while conserving very good mechanical properties.

### OBJECTS AND SUMMARY OF THE INVENTION

According to the present invention, the solution to the technical problem posed resides in the facts that the phenolic resin is selected from novolac phenol-formaldehyde resins and novolac cyanate ester resins, and that the material includes nodules of hardened phenolic resin dispersed throughout the material.

Regardless of whether it is electrical or optical, and regardless of whether it is for conveying power or data, a cable is constituted in outline by at least one electrical or optical conductor element that lies within at least one insulator element.

It should be observed that at least one of the insulator elements may also act as protection means and/or that the cable may also have at least one specific protection element constituting a sheath, in particular if the cable is an electric cable.

In the present invention, the layer may constitute an insulating layer or a protective sheath.

The Applicant has performed intensive testing to discover materials that enable very good fire performance to be guaranteed.

Thus, the Applicant has selected two types of hardenable phenolic resins, namely novolac phenol-formaldehyde resins and novolac cyanate ester resins.

Phenolic resins of the novolac type are generally formed by reacting a phenol with a formaldehyde in the presence of acid catalysts such as an inorganic acid or a strong organic acid.

The molar ratio of phenol/formaldehyde is equal to or greater than 1, with the molar ratio preferably lying in the range 1/0.4 to 1/0.9.

The excess phenol thus serves to guarantee that the chain ends have phenol rings.

Such novolac phenolic resins are typically solid, having melting points lying in the range 40° C. to 110° C. and molar masses lying in the range 250 grams per mole (g/mole) to 900 g/mole.

Generally, they are represented by the following formula I:

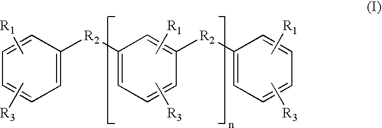

in which n is an integer greater than or equal to 0, with n preferably lying in the range 0 to 9.

According to the present invention, novolac phenol-formaldehyde resins comprise a residue R₁ of OH type, a residue R₂ of methyl type, and a residue R₃ of hydrogen or alkyl type.

According to the present invention, novolac cyanate ester resins comprise a residue R₁ of cyanate ester type, a residue R₂ of methyl type, and a residue R₃ of hydrogen or alkyl type.

It is known that novolac phenol-formaldehyde resins require a hardening agent to be added in order to enable them to cross-link.

The hardening agent may preferably be hexamethylene tetramine (HMTA), but may also be any other chemical species capable of inducing cross-linking in novolac phenol-formaldehyde resin.

In a particular embodiment, when the hardening agent is HMTA, the composition includes no more than 20% by weight of HMTA relative to the weight of novolac phenol-formaldehyde resin, and preferably no more than 10% by weight.

The preferred mass ratio for novolac phenol-formaldehyde resin over HTMA is about 90/10, making it possible to obtain both fast cross-linking kinetics and good thermomechanical properties.

In contrast, novolac cyanate ester resins do not require a hardening agent to enable them to cross-link.

Compositions of the present invention comprising a novolac cyanate ester resin may also include a catalyst for cross-linking cyanate ester groups, such as, for example: metallic salts or compounds of the imidazole type.

According to an essential characteristic of the invention, the polymer matrix of the composition needs to be thermoplastic.

The composition must be capable of being subjected to deformation under the action of heat without spoiling its properties for withstanding fire or its mechanical properties, in particular while it is being extruded as a layer in a power and/or telecommunications cable.

Thus, the composition must remain thermoplastic in order to obtain the material of the present invention.

More particularly, the thermoplastic polymer matrix must retain its thermoplastic properties after adding the phenolic resin of the present invention.

The composition preferably includes at least 50% by weight of said thermoplastic polymer matrix, and preferably at least 70% by weight.

In a particular embodiment, the composition includes no more than 30% by weight of phenolic resin in order to obtain a good compromise between ability to withstand fire and mechanical properties for the layer that is deposited on the cable.

Advantageously, the material of the present invention includes nodules of hardened phenolic resin, these nodules being dispersed uniformly within the entire material, or in other words throughout the thickness of the layer of said cable.

A power and/or telecommunications cable including at least one layer of said material thus presents optimized properties for withstanding fire together with optimized mechanical properties.

The term “nodules of hardened phenolic resin” is used to designate phenolic resin particles that have hardened in situ, i.e. hardened within the thermoplastic polymer matrix.

Consequently, the material of the present invention is obtained using a composition comprising a polar thermoplastic polymer matrix and a phenolic resin that has not yet hardened while it is being incorporated in said composition.

The in situ hardening of the phenolic resin advantageously serves to facilitate working, and also to facilitate dispersing the phenolic resin within the thermoplastic polymer matrix, before said resin hardens.

The material is then said more particularly to include “nodules” of hardened phenolic resin dispersed throughout the material. In order to obtain these nodules that are dispersed uniformly throughout the entire material, it is preferable for the thermoplastic polymer matrix to be polar.

The polar characteristic of said matrix makes it possible advantageously to obtain a composition in which the phenolic resin is completely or partially miscible in said matrix, and thus to obtain a layer, preferably an extruded layer, having the nodules of hardened phenolic resin distributed uniformly therein.

To do this, and in non-limiting manner, the polar thermoplastic polymer matrix may comprise a polar thermoplastic polymer selected from olefin polymers and/or copolymers containing at least one polar group, polyurethanes, polyesters, cyclic oligoesters, and polyvinyl chlorides, and mixtures thereof.

Said olefin copolymer is preferably a copolymer of ethylene that can be selected from an ethylene vinyl acetate (EVA) copolymer; an ethylene butyl acrylate (EBA) copolymer; an ethylene methyl acrylate copolymer; and an ethylene ethyl acrylate (EEA) copolymer.

Said olefin polymer is preferably a maleic anhydride grafted polyethylene (MAgPE) or a maleic anhydride grafted polypropylene (MAgPP).

Naturally, the polar thermoplastic polymer matrix may also include one or more non-polar polymers of the polypropylene or polyethylene type, with the polar polymers being in the majority compared with the non-polar polymers in order to avoid degrading the polar properties of said matrix.

According to a preferred characteristic of the invention, the phenolic resin can be cross-linked by thermosetting.

The term thermoset phenolic resin nodules is then used.

Two methods of preparing an extruded layer of a material of the present invention can be envisaged as a function of the reactivity of the not yet hardened novolac phenolic resin introduced into the composition, with the subject matter of the present invention not being limited to extrusion.

These two methods of preparation relate to thermosetting the phenolic resin in situ in order to obtain a material containing nodules of hardened phenolic resin in accordance with the present invention.

In order to avoid premature cross-linking of the phenolic resin, the polymer(s) making up said matrix must have a glass transition temperature and/or a softening temperature lower than the cross-linking temperature of the phenolic resin in order to encourage mixing of the resin within the matrix and thus make the composition more uniform.

The glass transition temperature of said polar thermoplastic polymers is preferably less than 150° C.

For a resin that is not very active, it is preferred to use a discontinuous method of preparation.

In a first step referred to as “mixing”, the polymer matrix and the hardenable phenolic resin are mixed together at a temperature lying between firstly the softening temperature and/or the glass transition temperature of the thermoplastic matrix, and secondly the temperature at which the cross-linking of the thermosetting resin begins, so as to leave time for the mixture to be made uniform.

This first step can be performed equally well in an internal mixer, in a two-screw extruder, on mixing cylinders, or by using any other tool for mixing polymers in the molten state.

In a second step referred to as “cross-linking”, the mixture from the first step is re-worked in a mixer or on cylinders at a temperature that is optimized for cross-linking the thermosetting resin.

This second step thus enables the phenolic resin to harden in situ and become dispersed uniformly throughout the bulk of the material.

The time and the cross-linking temperature depend on the selected phenolic resin.

In a third step referred to as “extrusion”, the resulting uniform material is extruded onto one or more bare or insulated conductors using an extruder.

For a resin that is more reactive, the mixing and the forming of the thermoset nodules can be performed by a method comprising a single step.

The temperature profile increases from the softening temperature of the thermoplastic matrix up to the cross-linking temperature of the thermosetting resin, and typically it may rise within the range 70° C. to 220° C.

The speed of rotation and the profile of the screws and also the delivery rate of the extruder feeders can be determined easily by the person skilled in the art so as to guarantee a transit time that is sufficient to ensure that optimized cross-linking of the hardenable phenolic resin is achieved.

Advantageously, the extruded layer presents fire-withstanding performance that is significantly improved, while retaining satisfactory mechanical properties.

In another particular embodiment, the composition contains in inorganic filler, preferably a metal hydroxide of the magnesium dihydroxide (MDH) or aluminum trihydroxide (ATH) type.

The inorganic filler may also be selected from carbonates, oxides, clays, and silicates, well known to the person skilled in the art.

In particularly advantageous manner, combining nodules of hardened phenolic resin with one or more inorganic fillers of the fire-retardant type enables significantly improved fire reaction results to be achieved, in particular with a quantity of inorganic filler that is considerably less than used in the prior art.

In another embodiment, the composition includes a compatibility agent.

The compatibility agent is a thermoplastic polymer grafted or copolymerized with functional groups, the thermoplastic polymer being miscible in the thermoplastic polymer matrix and the reactive functional groups improving the interface with the phenolic resin.

For example, when the thermoplastic polymer matrix is based on EVA, the compatibility agent may be an ethylene vinyl acetate and maleic anhydride copolymer of the OREVAC type sold by the supplier Arkema.

The compatibility agent serves to reduce the stiffness of the thermoplastic material by reducing the size of the particles, more particularly the size of the nodules formed in situ in the material.

By way of example, the compatibility agent makes it possible to reduce the size of the nodules by a factor of 2, with the size of the nodules going from about 1 micrometer (μm) to about 0.5 μm.

Preferably, the compatibility agent may be incorporated in the composition with a ratio by weight of the polymer matrix over the compatibility agent of about 90/10.

### MORE DETAILED DESCRIPTION

Other characteristics and advantages of the present invention appear in the light of examples given below, said examples being given by way of non-limiting illustration.

In order to show the advantages of materials obtained from compositions of the present invention, Table 1 lists the various ingredients of said compositions of the invention and of the prior art, for which the mechanical properties and fire-withstanding properties were studied.

It should be observed that in Table 1 below:
the quantities mentioned of EVA28, of novolac resin, and of HTMA are expressed in percentages by weight relative to the weight of the composition; and
the quantities mentioned of MDH and of ATH are expressed in parts per hundred (pph) parts of the mixture constituted by the polymer matrix, the phenolic resin, if any, and the hardening agent, if any.

TABLE 1

| Composition | EVA18 | Novolac | HMTA | MDH | ATH |
|---|---|---|---|---|---|
| 1 | 100 | 0 | 0 | 0 | 0 |
| 2 | 80 | 20 | 0 | 0 | 0 |
| 3 | 80 | 18 | 2 | 0 | 0 |
| 4 | 80 | 18 | 2 | 50 | 0 |
| 5 | 80 | 18 | 2 | 100 | 0 |
| 6 | 80 | 18 | 2 | 150 | 0 |
| 7 | 80 | 20 | 0 | 150 | 0 |
| 8 | 100 | 0 | 0 | 150 | 0 |
| 9 | 80 | 18 | 2 | 0 | 150 |
| 10 | 100 | 0 | 0 | 0 | 150 |

The origins of the various ingredients in Table 1 were as follows:
EVA28 (polymer matrix) corresponds to the ethylene vinyl acetate copolymer sold under the reference Evatane 2803 by the supplier Arkema;
novolac corresponds to the novolac resin sold under the reference 4439X by the supplier Dynea;
HMTA corresponds to the hexamethylene tetramine sold by the supplier Aldrich;
MDH corresponds to the magnesium dihydroxide sold under the reference Magnifin H10 by the supplier Albemarle; and

ATH corresponds to the aluminum trihydroxide sold under the reference Martinal OL104 WE by Albemarle.

The compositions referenced 1, 2, 7, 8, and 10 correspond to comparative tests in which the compositions do not include any hardening agent, while the compositions referenced 3 to 6 and 9 are those that relate to the present invention.

To study the mechanical properties and the fire reaction properties, samples 1 to 10 corresponding respectively to compositions 1 to 10 in Table 1, were prepared using the thermosetting protocol set out below.

The total weight prepared for each sample was set at 250 grams (g).

The samples were prepared in an internal mixer at 110° C. operating at 50 revolutions per minute (rpm). Initially, the EVA28 was introduced therein, followed by the fire-retardant filler, when present in the composition, and finally by novolac, said composition then being mixed for 15 minutes (min).

Each mixture was then made uniform using forming cylinders.

In compositions containing HMTA, this hardening agent was introduced directly on cylinders, with the working time being 30 min at 150° C., which temperature is the cross-linking temperature of novolac phenol-formaldehyde resin.

This is how the novolac resin was thermoset in compositions 3 to 6 and 9.

Consequently, the respective samples obtained from compositions 3 to 6 and 9 contained thermoset nodules dispersed throughout their EVA28 matrix.

For fire testing, each sample as obtained in that way was shaped into square plates having a side of 10 centimeters (cm) and a thickness of 3 mm, using a press and a calibrated mold.

The pressing temperature was 120° C., with pressing time being 5 min and the pressure set at 100 bar.

Fire behavior was evaluated using a calorimeter cone. The calorimeter cone tests were carried out with an incident heat flux of 50 kilowatts per square meter (kW/m²) in compliance with ISO standard 5660-1.

The testing serves to measure ignition time expressed in seconds, peak heat release expressed in kW/m², and mean heat release expressed in kW/m² for each sample.

The smaller the peak release heat and the mean heat release, numerically speaking, and conversely the greater the value for the ignition time, the better the fire-retardant properties of the composition.

To evaluate the mechanical properties of the various samples, tensile testing plates were made under the same conditions as those set out above, but with a calibrated mold of a thickness of 1 millimeter (mm).

Tensile testing was performed on standardized test pieces of H2 type with a thickness of 1 mm and with a travel speed of 200 millimeters per minute (mm/min).

Testing serves to obtain stress and elongation at break, expressed respectively in megapascals (MPa) and percentage (%) for each sample.

The results of fire performance testing and tensile testing to break for samples 1 to 10 are summarized in Tables 2 to 4 below.

In order to show the improvement of fire performance achieved by hardening the novolac phenol-formaldehyde resin, sample 3 as compared with samples 1 and 2 gave the results shown in Table 2 below.

TABLE 2

| | Ignition time | Peak heat | Mean heat |
|---|---|---|---|
| Sample | (s) | release (kW/m²) | release (kW/m²) |
| 1 | 40 | 1468 | 488 |
| 2 | 40 | 825 | 175 |
| 3 | 39 | 681 | 132 |

| Sample | Stress at break (MPa) | Elongation at break (%) |
|---|---|---|
| 1 | 25.2 | 756 |
| 2 | 26.6 | 628 |
| 3 | 22.3 | 663 |

Firstly, the peak heat release and mean heat release values are considerably reduced after adding only 20% novolac resin.

Furthermore, the cross-linking of novolac resin by HMTA makes it possible to increase quite remarkably the influence of the novolac resin on the fire properties of sample 3 as can be seen from the difference between samples 2 and 3, with the mechanical properties otherwise remaining very good for use as a cable-making material.

Furthermore, samples 4 to 6, shown in Table 3, reveal synergy between the hardened novolac resin and adding a fire-retardant filler in the composition of the present invention.

TABLE 3

| | Ignition time | Peak heat | Mean heat |
|---|---|---|---|
| Sample | (s) | release (kW/m²) | release (kW/m²) |
| 3 | 39 | 681 | 132 |
| 4 | 52 | 294 | 101 |
| 5 | 70 | 174 | 95 |
| 6 | 78 | 164 | 64 |
| 7 | 93 | 182 | 81 |
| 8 | 74 | 328 | 103 |

| Sample | Stress at break (MPa) | Elongation at break (%) |
|---|---|---|
| 3 | 22.3 | 663 |
| 4 | 7.1 | 299 |
| 5 | 7.9 | 119 |
| 6 | 11.2 | 51 |
| 7 | 6.3 | 152 |
| 8 | 9.2 | 115 |

A comparison between sample 8 and sample 4 shows that in the presence of the hardening agent, the proportion of MDH can be reduced to 50 pph while conserving equivalent fire properties.

Furthermore, and in particularly advantageous manner, sample 4 presents elongation at break that is 2.6 times greater than that of sample 8.

Therefore, sample 6 reveals, when compared with sample 7, the advantage of combining novolac resin with the hardening agent in the presence of a fire-retardant filler in terms of optimizing fire-retardant properties, said properties of sample 6 being improved over those of sample 7.

It can be observed that the peak heat release and the mean heat release are decreased because of the cross-linking of the novolac phenol-formaldehyde resin (sample 6).

Finally, by comparing samples 6 and 8 with respect to their fire-retardant properties, associating 150 pph of MDH with the hardened novolac serves to reduce exceptionally (by about 50%) both the peak heat release and the mean heat release for similar ignition time.

Table 4 shows the synergy between hardened novolac resin and added ATH, as a fire-retardant filler, in the composition of the present invention.

TABLE 4

| | Ignition time | Peak heat | Mean heat |
|---|---|---|---|
| Sample | (s) | release (kW/m²) | release (kW/m²) |
| 9 | 88 | 155 | 71 |
| 10 | 60 | 190 | 87 |

| Sample | Stress at break (MPa) | Elongation at break (%) |
|---|---|---|
| 9 | 6.9 | 78 |
| 10 | 5.5 | 168 |

It can clearly be seen that the ignition time and thus the peak heat release and the mean heat release of sample 9 are better than those of sample 10.

In order to validate samples of these types on cables, samples similar to samples 1 to 10 were prepared using the above-described thermosetting protocol.

However, the step of introducing the hardening agent directly on a cylinder was followed by a step of extruding said samples onto a copper wire having a section of 2.5 square millimeters (mm²), with extrusion taking place with a temperature profile lying in the range 120° C. to 150° C.

The copper wire was thus covered in a layer of extruded material corresponding to samples 1 to 10 obtained from the compositions of Table 1, with said layer having a thickness of 650 μm.

That type of preparation makes use of a so-called discontinuous method as mentioned in the introduction to the present description.

Fire testing was performed using a calorimeter cone with an incident heat flux of 50 kW/m² on 32 pieces of those insulating conductors each having a length of 10 cm and disposed in parallel while being held together by a copper wire.

The release heat results are summarized in Table 5 below.

TABLE 5

| Sample extruded | Peak heat release | Mean heat release |
|---|---|---|
| onto copper wire | (kW/m²) | (kW/m²) |
| 1 | 516 | 180 |
| 2 | 280 | 59 |
| 3 | 243 | 49 |
| 4 | 106 | 34 |
| 5 | 59 | 30 |
| 6 | 88 | 26 |
| 7 | 65 | 27 |
| 8 | 119 | 41 |
| 9 | 52 | 21 |
| 10 | 73 | 30 |

The ignition times are identical to those of Tables 2 to 4. The peak heat release and the mean heat release are proportional to the results obtained using molded plates (see Tables 2 to 4).

Thus, the conclusions relating to the results of molded samples 1 to 10 are identical to those relating to those of the samples when extruded on an electrical conductor.

What is claimed is:

1. A power and/or telecommunications cable including at least one layer of a material obtained from a composition comprising:
a thermoplastic polymer matrix; and
a phenolic resin;
wherein said phenolic resin is selected from novolac phenol-formaldehyde resins and novolac cyanate ester resins, and wherein said material includes nodules of hardened phenolic resin dispersed throughout the material.

2. A cable according to claim 1, wherein the composition includes at least 50% by weight of said polymer matrix.

3. A cable according to claim 1, wherein the thermoplastic polymer matrix comprises an olefin polymer and/or copolymer containing at least one polar group.

4. A cable according to claim 3, wherein the olefin copolymer is selected from the group consisting of: an ethylene vinyl acetate copolymer; an ethylene butyl acrylate copolymer; an ethylene methyl acrylate copolymer; and an ethylene ethyl acrylate copolymer.

5. A cable according to claim 3, wherein the olefin polymer is a maleic anhydride grafted polyethylene or a maleic anhydride grafted polypropylene.

6. A cable according to claim 1, wherein the composition includes no more than 30% by weight of phenolic resin.

7. A cable according to claim 1, wherein the composition includes an inorganic filler.

8. A cable according to claim 7, wherein the inorganic filler is a metallic hydroxide.

9. A cable according to claim 8, wherein the metallic hydroxide is magnesium dihydroxide or aluminum trihydroxide type.

10. A cable according to claim 1, wherein the composition includes a compatibility agent.

11. A cable according to claim 4, wherein the composition includes a compatibility agent, and wherein the compatibility agent is a copolymer of ethylene vinyl acetate and maleic hydride.

12. A cable according to claim 1, wherein when the phenolic resin is a novolac phenol-formaldehyde resin, said composition further includes a hardening agent.

13. A cable according to claim 12, wherein the hardening agent is hexamethylene tetramine.

14. A cable according to claim 13, wherein the ratio by weight of novolac phenol-formaldehyde resin over HMTA is of the order of 90/10.

15. A cable according to claim 1, wherein the thermoplastic polymer matrix is polar.

16. A cable according to claim 2, wherein the composition includes at least 70% by weight of said polymer matrix.
